(19) United States
(12) Patent Application Publication
(10) Pub. No.: US 2025/0163348 A1
(43) Pub. Date: May 22, 2025

(54) A BLOCK COPOLYMER, PREPARATION PROCESS AND COMPOSITION THEREOF

(71) Applicant: BASF SE, Ludwigshafen Am Rhein (DE)

(72) Inventors: Alexandros LAMPROU, Shanghai (CN); Yi Feng DU, Shanghai (CN); Ya Jing LIU, Shanghai (CN); Fei Mo SHI, Shanghai (CN); Chengke QU, Shanghai (CN); Guowei WANG, Shanghai (CN); Christian SCHADE, Ludwigshafen am Rhein (DE); Junpo HE, Shanghai (CN)

(21) Appl. No.: 18/841,463

(22) PCT Filed: Mar. 17, 2023
(86) PCT No.: PCT/EP23/56966

§ 371 Date: Aug. 26, 2024

(30) Foreign Application Priority Data
Mar. 24, 2022 (WO) PCT/CN22/82782

(51) Int. Cl. C11D 3/37; C08F 293/00; C11D 1/14; C11D 1/22; C11D 1/72; C11D 1/83; C11D 3/00; C11D 3/20; C11D 3/48

(52) U.S. Cl. CPC C11D 3/3707; C08F 293/005; C11D 1/83; C11D 3/0021; C11D 3/2068; C11D 3/48; C08F 2438/03; C11D 1/146; C11D 1/22; C11D 1/72

(57) ABSTRACT

Disclosed herein are a block copolymer of polyalkylene oxide and polyvinyl ester, and its use in a fabric or home care product as anti-greying agent. Further disclosed herein is a detergent composition including the block copolymer.

### TECHNICAL FIELD

The present invention is related to a block copolymer of polyalkylene oxide and polyvinyl ester, and its use in a fabric or home care product as anti-greying agent. The present invention is more particular related to a detergent composition comprising the block copolymer.

### BACKGROUND ART

Greying is caused by soil, fat or dye particles to the laundry item which have been detached during the washing process reattaching from the wash liquor. In most cases, this process is irreversible; subsequent washing is unable to remove this soil again. Greying occurs in particular in the case of fabrics which contain synthetic fibers, in particular in the case of textile which contain polyester fibers. Phosphates are essential detergent constituents and have a water-softening action and, moreover, act as greying inhibitors. Because of legislative measures, it is necessary in some countries to greatly reduce the content of phosphates in detergents, or to offer phosphate-free detergents. The absence of the phosphates leads to more considerable greying. This is countered by special phosphate-free additives which have an anti-greying effect in the detergent. Some of these additives also improve the soil release during the washing operation and thus improve the washing performance.

EP 0219048A discloses the use of graft polymers as greying inhibitors in the washing and aftertreatment of textile ware which contains synthetic fibers. The graft polymers are obtained by grafting polyalkylene oxides with vinyl acetate.

EP 0285037a discloses an identical use where the graft polymers are obtained by grafting polyalkylene oxides which are terminally capped at one end with an ester chosen from vinyl esters of a saturated C₁-C₆-monocarboxylic acid, methyl and ethyl esters of acrylic acid and methacrylic acid.

EP 0285038A discloses an identical use where the graft polymers are obtained by grafting polyalkylene oxides with N-vinylpyrrolidone and an ester chosen from vinyl esters of a saturated C₁-C₆-monocarboxylic acid, methyl and ethyl esters of acrylic acid and methacrylic acid.

However, in view of the prior art, there exists a need for developing a new greying inhibitor for a cleansing/detergent formulation to have more satisfied anti-greying effect.

In addition, as most washing operation both domestic and commercial employ detergents with low biodegradability, the wash water is ultimately released into large water bodies. It is common knowledge that some commonly used detergents increase the COD of water resulting on depletion of dissolved oxygen and harm to aquatic life.

Accordingly, another object of the present invention is to provide an eco-friendly detergent with more satisfied anti-greying effect and more biodegradable causing less harm to humans, animals and/or water systems.

### SUMMARY OF INVENTION

In one aspect, the present invention is directed to a block copolymer comprising a block A and a block B, wherein the block A comprises units deriving from at least one vinyl ester monomer, wherein the block B comprises units deriving from at least one monomer selected from the group consisting of ethylene oxide, 1,2-propylene oxide, 1,2-butyl oxide, 2,3-butylene oxide, 1,2-pentene oxide and 2,3-pentene oxide; preferably, the block copolymer is a (block A)-(block B) diblock polymer; more preferably the block copolymer is a (block A)-(block B)-(block A) triblock polymer.

Preferably, the block A comprises units deriving from at least one vinyl ester monomer selected from vinyl formate, vinyl acetate, vinyl propionate, vinyl butyrate, vinyl stearate, vinyl laurate and vinyl benzoate; more preferably vinyl formate, vinyl acetate or vinyl propionate; still more preferably vinyl acetate.

Preferably, the block B comprises units deriving from at least one monomer selected from ethylene oxide, propylene oxide and butylene oxide; more preferably ethylene oxide.

In another aspect, the present invention is related to a detergent composition comprising the block copolymer and at least one detersive surfactant. The at least one detersive surfactant is selected from the group consisting of anionic surfactant, non-ionic surfactant, and mixture thereof.

In a further aspect, the present invention is related to a process of preparation of the block polymer comprising
a) reacting at least one monomer selected from the group consisting of ethylene oxide, 1,2-propylene oxide, 1,2-butyl oxide, 2,3-butylene oxide, 1,2-pentene oxide, optionally a radical initiator, and a chain transfer agent, to obtain the first block B, the transfer agent being bounded to the block B;
b) reacting the block B, at least one vinyl ester monomer, optionally at least one radical initiator to obtain the block copolymer; wherein the chain transfer agent is selected from the group consisting of dithioesters, thioethers-thiones, trithiocarbonates, dithiocarbamates, xanthates, their derivatives and mixtures thereof.

In still another aspect, the present invention is related to use of the block copolymer in a fabric and home care product, a cleaning composition, or an industrial and institutional cleaning product, cosmetic or personal care product, oil field-formulation such as crude oil emulsion breaker, pigment dispersion for example inks such as ink-jet inks, electro-plating product, cementitious composition, lacquer, paint, agrochemical formulations.

### DESCRIPTION

As used herein, the articles “a” and “an” when used in a claim, are understood to mean one or more of what is claimed or described. As used herein, the terms “include(s)” and “including” are meant to be non-limiting, and thus encompass more than the specific item mentioned after those words.

The compositions of the present disclosure can “comprise” (i.e. contain other ingredients), “consist essentially of” (comprise mainly or almost only the mentioned ingredients and other ingredients in only very minor amounts, mainly only as impurities), or “consist of” (i.e. contain only the mentioned ingredients and in addition may contain only impurities not avoidable in an technical environment, preferably only the ingredients) the components of the present disclosure.

Similarly, the terms “substantially free of” or “substantially free from” or “(containing/comprising) essentially no” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

The term “about” as used herein encompasses the exact number “X” mentioned as e.g. “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course if the value X given itself is already “100%” (such as for purity etc.) then the term “about” clearly can and thus does only mean deviations thereof which are smaller than “100”.

The phrase “fabric care composition” is meant to include compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, and as further detailed herein below when describing the use and application of the inventive graft polymers and compositions comprising such graft polymers.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure. In all embodiments of the present disclosure, all percentages are by weight of the total composition, unless specifically stated otherwise. All ratios are weight ratios, unless specifically stated otherwise.

### Block Copolymer

The term “block (co)polymer” as used herein means that the respective polymer comprises at least two (i.e., two, three, four, five or more) homo- or co-polymer subunits (“blocks”) linked by covalent bonds. “diblock” copolymers have two distinct blocks (homo- and/or co-polymer subunits), whereas “triblock” copolymers have, by consequence, three distinct blocks (homo- and/or co-polymer subunits) and so on. The number of individual blocks within such block copolymers is not limited; by consequence, a “n-block copolymer” comprises n distinct blocks (homo- and/or co-polymer subunits). Within the individual blocks the size/length of such a block may vary independently from the other blocks. The smallest length/size of a block is based on two individual monomers (as a minimum), but may be as large as 50.

The block copolymer of the present invention comprising a block A and a block B, wherein the block A comprises units deriving from at least one vinyl ester monomer, wherein the block B comprises units deriving from at least one monomer selected from the group consisting of ethylene oxide, 1,2-propylene oxide, 1,2-butyl oxide, 2,3-butylene oxide, 1,2-pentene oxide and 2,3-pentene oxide.

In some preferred embodiments, the block A comprises repeating units deriving from at least one vinyl ester selected from the group consisting of vinyl formate, vinyl acetate, vinyl haloacetate, vinyl propionate, vinyl butyrate, vinyl stearate, vinyl benzoate, vinyl pivalate, vinyl octanoate, vinyl neodecanoate and vinyl laurate, preferably vinyl formate, vinyl acetate or vinyl propionate.

In some preferred embodiments, the block B comprises repeating units deriving from ethylene oxide or propylene oxide, more preferably from ethylene oxide.

In some preferred embodiments, the block copolymer is a (block A)-(block B) diblock polymer; In some preferred embodiments, the block copolymer is a (block A)-(block B)-(block A) triblock polymer.

According to any one embodiments of the present invention, the molecular weight of the inventive 40 block copolymer as given as “Mₙ” (number average molecular weight) in g/mol is within 5000 to 15000, preferably from 5500 to 13000, more preferably from 6000 to 12500.

According to any one embodiments of the present invention, the number average molecular weight Mₙ in g/mol of the block B is within 2500 to 8000, preferably from 3000 to 8000, more preferably from 3500 to 6500. The number average molecular weight of the respective values of Mₙ of the inventive block copolymer and the block B can be determined by Gel Permeation Chromatography (GPC) as described within the experimental section hereinbelow.

According to any one embodiments of the present invention, the number average molecular weight Mₙ in g/mol of the block A is within 200 to 10000 g/mol, preferably within 300 to 8500 g/mol, more preferably from 350 to 8000 g/mol, still more preferably from 400 to 7500 g/mol. The Mn of the block A is calculated based on the Mn of the block B measured by GPC and the weight ratio of the block A to the block B measured by NMR.

In some embodiments, the degree of polymerization of the block B is in the range of 70 to 170, for example in the range of 80 to 160, or in the range of 85 to 150. The degree of polymerization of the block A is in the range of 1 to 120, for example in the range of 3 to 100, or in the range of 5 to 90. The respective values of degree of polymerization of the block A and the block B can be determined as described within the experimental section herein below.

The degree of polymerization (DP) of block B is calculated based on the number-average molecular weight of block B determined by MALDI-TOF-MS (Applied Biosystems Sciex 5800 MALDI-TOF-MS, Matrix: trans-2-[3-(4-t-butylphenyl)-2-methyl-2-propenyli-dene]malononitrile (DCTB), N₂ Laser at 337 nm), before reaction. The DP of block A is calculated based on the number-average molecular weight of block A determined by NMR (400 Hz, CDCl₃), by taking into account the characteristic resonance signals of block B and block A after reaction, as well as the molecular weight of block B, as determined before reaction.

In a further aspect, the inventive block copolymer should have beneficial properties in respect of biodegradability of a certain level. In particular, such biodegradability of the block polymer is at least 40%, preferably at least 45%, even more preferably at least 50% within 28 days when tested under OECD301F with the measurement method see also experimental section).

In a further embodiment, the number average molecular weight (Mₙ) ratio of the block B to the block A is within 0.4:1 to 15:1, preferably within 0.6:1 to 12:1. The value of Mₙ ratio can be determined by Nuclear magnetic resonance (NMR) as described within the experimental section hereinbelow.

In some preferred embodiments, the inventive block copolymer is a (block A)-(block B)-(block A) triblock polymer. The molecular weight of the inventive block copolymer as given as “Mₙ” (number average molecular weight) in g/mol is within 5000 to 15000, preferably from 5500 to 13000, more preferably from 6000 to 12500, most preferably from 7000 to 12500. The number average molecular weight Mₙ in g/mol of the block B is within 2500 to 8000, preferably from 3000 to 8000, more preferably from 3500 to 6500. The number average molecular weight of the respective values of Mₙ of the inventive block copolymer and the block B can be determined by Gel Permeation Chromatography (GPC) as described within the experimental section hereinbelow. The number average molecular weight Mₙ in g/mol of the block A is within 200 to 10000 g/mol, preferably within 300 to 8500 g/mol, more preferably from 350 to 8000 g/mol, still more preferably from 400 to 7500 g/mol. The Mn of the block A is calculated based on the Mn of the block B measured by GPC and the weight ratio of the block A to the block B measured by NMR. The degree of polymerization of the block B is in the range of 80 to 160, for example in the range of 85 to 150, or in the range of 90 to 140. The degree of polymerization of the block A is in the range of 1 to 120, for example in the range of 3 to 100, or in the range of 5 to 90.

### Process

The inventive block copolymer obtained by a living or controlled free-radical polymerization process may comprise at least one chain transfer agent at an end of the polymer chain. In particular embodiment such a group is removed or deactivated.

The term “radical polymerization” as used within the context of the present invention comprises besides the free radical polymerization also variants thereof, such as controlled radical polymerization. Suitable control mechanisms are RAFT, NMP or ATRP, which are each known to the skilled person, including suitable control agents.

The invention also encompasses a process for obtaining a block polymer as detailed herein before, wherein the process comprise
a) reacting at least one monomer selected from the group consisting of ethylene oxide, 1,2-propylene oxide, 1,2-butyl oxide, 2,3-butylene oxide, 1,2-pentene oxide, optionally a radical initiator, and a chain transfer agent, to obtain the first block B, the chain transfer agent being bound to the block B;
b) reacting the block B, at least one vinyl ester monomer, optionally at least one radical initiator to obtain the block copolymer; wherein the chain transfer agent is selected from the group consisting of dithioesters, thioethers-thiones, trithiocarbonates, dithiocarbamates, xanthates and mixtures thereof;
Optionally c), the process comprising a step of reacting the chain transfer agent with means to render it inactive.

In a preferred embodiment, the living or controlled radical polymerization process used to make the di-block copolymer comprising the steps of
a) reacting at least one monomer selected from the group consisting of ethylene oxide, 1,2-propylene oxide, 1,2-butyl oxide, 2,3-butylene oxide, 1,2-pentene oxide, optionally a radical initiator, and a chain transfer agent, to obtain the first block B, the chain transfer agent being bound at one end of the block B polymer chain;
b) reacting the block B, at least one vinyl ester monomer, optionally at least one radical initiator to obtain the block copolymer; wherein the chain transfer agent is selected from the group consisting of dithioesters, thioethers-thiones, trithiocarbonates, dithiocarbamates, xanthates, their derivatives and mixtures thereof.
Optionally c), the process comprising a step of reacting the chain transfer agent with means to render it inactive.

In a preferred embodiment, the living or controlled radical polymerization process used to make the tri-block copolymer comprising the steps of
a) reacting at least one monomer selected from the group consisting of ethylene oxide, 1,2-propylene oxide, 1,2-butyl oxide, 2,3-butylene oxide, 1,2-pentene oxide, optionally a radical initiator, and a chain transfer agent, to obtain the first block B, the transfer agent being bound at both ends of the block B polymer chain;
b) reacting the block B, at least one vinyl ester monomer, optionally at least one radical initiator to obtain the block copolymer; wherein the chain transfer agent is selected from the group consisting of dithioesters, thioethers-thiones, trithiocarbonates, dithiocarbamates, xanthates, their derivatives and mixtures thereof.
Optionally c), the process comprising a step of reacting the chain transfer agent with means to render it inactive.

Preferred processes are sequenced living/controlled free-radical polymerization processes, involving the use of a chain transfer agent. Preferred chain transfer agents are agents comprising a group of formula —S—C(S)—Y—, —S—C(S)—S—, or —S—P(S)—Y—, or —S—P(S)—S—, wherein Y is an atom different from sulfur, such as an oxygen atom, a nitrogen atom, and a carbon atom. They include dithioester groups, thioether-thione groups, dithiocarbamate groups, dithiphosphoroesters, dithiocarbazates and xanthate groups. A preferred polymerization process is a living/controlled radical free-radical polymerization process using xanthates or its derivatives, more preferably the chain transfer agent used in the radical polymerization process includes 2-((Ethoxycarbonothioyl)thio)acetic acid, dibenzyl trithiocarbonate, 3-((((1-carboxyethyl)thio)carbonothioyl)thio)propanoic acid, 2,2′-[Carbonothioylbis(thio)]bis[2-methylpropanoic acid], Methyl 3-((1-methoxy-1-oxopropan-2-ylthio)carbonothioylthio)propanoate, Benzyl butyl carbonotrithioate, Methyl 2-(butylthiocarbonothioylthio)propanoate.

The radical polymerization as such is also known to a skilled person. That person also knows that the inventive process can be carried out in the presence of a radical initiator (C) and/or at least one solvent. The skilled person knows the respective components as such.

The polymerization initiator used in the polymerization of an unsaturated carboxylic acid and a hydrophilic comonomer in an aqueous medium is not particularly limited, so far as the polymerization initiator is usable in the polymerization in a conventional aqueous system, and a conventional polymerization initiator can be properly selected. Such polymerization initiators include, for example, those which are radically decomposed thermally or with a reducing material to allow addition polymerization of the monomer to proceed, and examples thereof include water-soluble or oil-soluble persulfates, peroxides, or azobis compounds. Specific examples thereof include potassium persulfate, ammonium persulfate, t-butylhydroperoxide, hydrogen peroxide, and azobisisobutyronitrile (AIBN). They may be used either solely or in a combination of two or more of them. In a preferred embodiment, the initiator used in the radical polymerization is azobisisobutyronitrile (AIBN).

The inventive polymerization reaction can be carried out in the presence of, preferably small amounts of, an organic solvent. It is of course also possible to use mixtures of different solvents.

Preference is given to using water-soluble or water-miscible solvents.

Examples of suitable solvents include:
monohydric alcohols, preferably aliphatic C₁-C₅-alcohols, more preferably aliphatic C₂-C₁₂-alcohols, most preferably C₂-C₄-alcohols, such as ethanol, propanol, isopropanol, butanol, sec-butanol and tert-butanol;
polyhydric alcohols, preferably C₂-C₁₀-diols, more preferably C₂-C₅-diols, most preferably C₂-C₄-alkylene glycols, such as ethylene glycol, 1,2-propylene glycol and 1,3-propylene glycol;
alkylene glycol ethers, preferably alkylene glycol mono(C₁-C₁₂-alkyl) ethers and alkylene glycol di(C₁-C₅-alkyl) ethers, more preferably alkylene glycol mono- and di(C₁-C₂-alkyl) ethers, most preferably alkylene glycol mono(C₁-C₂-alkyl) ethers, such as ethylene glycol monomethyl and -ethyl ether and propylene glycol monomethyl and -ethyl ether;
polyalkylene glycols, preferably poly(C₂-C₄-alkylene) glycols having 2-20 C₂-C₄-alkylene glycol units, more preferably polyethylene glycols having 2-20 ethylene glycol units and polypropylene glycols having 2-10 propylene glycol units, most preferably polyethylene glycols having 2-15 ethylene glycol units and polypropylene glycols having 2-4 propylene glycol units, such as diethylene glycol, triethylene glycol, dipropylene glycol and tripropylene glycol;
polyalkylene glycol monoethers, preferably poly(C₂-C₄-alkylene) glycol mono(C₁-C₂₅-alkyl) ethers having 2-20 alkylene glycol units, more preferably poly(C₂-C₄-alkylene) glycol mono(C₁-C₂₀-alkyl) ethers having 2-20 alkylene glycol units, most preferably poly(C₂-C₃-alkylene) glycol mono(C₁-C₁₆-alkyl) ethers having 3-20 alkylene glycol units;
carboxylic esters, preferably C₁-C₅-alkyl esters of C₁-C₆-carboxylic acids, more preferably C₁-C₄-alkyl esters of C₁-C₃-carboxylic acids, most preferably C2-C4-alkyl esters of C₂-C₃-carboxylic acids, such as ethyl acetate and ethyl propionate;
aliphatic ketones which preferably have from 3 to 10 carbon atoms, such as acetone, methyl ethyl ketone, diethyl ketone and cyclohexanone;
cyclic ethers, in particular tetrahydrofuran.

The solvents are advantageously those solvents, which are also used to formulate the inventive block copolymers for use (for example in washing and cleaning compositions) and can therefore remain in the polymerization product.

### Composition

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

“Compositions for Fabric and Home Care” include cleaning compositions including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, light duty liquid detergents compositions, heavy duty liquid detergent compositions, detergent gels commonly used for laundry, bleaching compositions, laundry additives, fabric enhancer compositions, and other suitable forms that may be apparent to one skilled in the art in view of the teachings herein. Such compositions may be used as a pre-laundering treatment, a post-laundering treatment, or may be added during the rinse or wash cycle of the laundering operation, preferably during the wash cycle of the laundering or dish washing operation. More preferably, such Composition for Fabric and Home Care is a laundry cleaning composition, a laundry care product or laundry washing product, most preferably a liquid laundry detergent formulation or liquid laundry detergent product.

In principle the block polymers of this invention can be employed in any application to replace known detergent polymers of similar composition, such applications are for example: Cosmetics, Personal Care: Such compositions and formulations include shampoos, lotions, gels, sprays, soap, make-up powder, lipsticks, hairspray.

Technical applications: Such compositions and formulations include glues of any kind, non-water and preferably water-based liquid formulations or solid formulations, the use as dispersant in dispersions of any kind, such as in oilfield applications, automotive applications, typically where a solid or a liquid is to be dispersed within another liquid or solid.

Lacquer, paints and colorants formulations: Such compositions and formulations include non-water and—preferably—water-based lacquer and colourants, paints, finishings.

Agricultural Formulations: Such compositions and formulations include formulations and compositions containing agrochemical actives within a liquid, semi-solid, mixed-liquid-solid or solid environment.

Aroma Chemical-formulations: Such compositions and formulations include formulations which dissolve or disperse aroma chemicals in liquid or solid compositions, to evenly disperse and/or retain their stability, so as to retain their aroma profile over extended periods of time; encompassed are also compositions that show a release of aroma chemicals over time, such as extended release or retarded release formulations.

Hence, another subject matter of the present invention is the use of the block copolymers of the invention and/or obtained by or obtainable by a process of the invention and/or as detailed before in fabric and home care products, in cosmetic and personal care formulations, as crude oil emulsion breaker, in technical applications including in pigment dispersions for ink jet inks, in formulations for electro plating, in cementitious compositions, in agrochemical formulations as e.g. dispersants, crystal growth inhibitor and/or solubilizer, in lacquer and colorants formulations, preferably in agrochemical compositions and cleaning compositions and in fabric and home care products, in particular cleaning compositions for improved oily and fatty stain removal, removal of solid dirt such as clay, prevention of greying of fabric surfaces, and/or anti-scale agents and in particular for inhibiting the transfer of dyes, wherein the cleaning composition is preferably a laundry detergent formulation and/or a dish wash detergent formulation, more preferably a liquid laundry detergent formulation and/or a liquid manual dish wash detergent formulation.

Another subject-matter of the present invention is, therefore, also a cleaning composition, fabric and home care product, industrial and institutional cleaning product, cosmetic or personal care product, oil field-formulation such as crude oil emulsion breaker or dispersants or gas hydrate inhibitors, pigment dispersion for e.g. ink jet inks and inks containing the graft polymer, electro plating product, cementitious composition, lacquer, paint, agrochemical formulations, preferably in laundry detergents, in cleaning compositions and/or in fabric and home care products, each comprising at least one graft polymer as defined above or obtained by or obtainable by a process of the invention and/or as detailed herein.

Hence, a preferred subject matter of the invention is also the use of at least one inventive block copolymer and/or at least one block copolymer obtained or obtainable by the inventive process in fabric and home care products, preferably in cleaning compositions and in laundry treatment, laundry care products and laundry washing products, more preferably a laundry detergent formulation, even more preferably a liquid laundry detergent formulation. In particular, the inventive block polymer is employed in such composition/product/formulation for improved greying inhibition.

Another subject-matter of the present invention is, therefore, a cleaning composition, a fabric and home care product, preferably a laundry cleaning composition, a laundry treatment product or laundry care product or laundry washing product, preferably a liquid laundry detergent formulation or liquid laundry detergent product, containing at least one block polymer of the invention and/or at least one block polymer obtained or obtainable by the inventive process, such composition or product exhibiting improved greying inhibition.

In one embodiment it is also preferred that the cleaning composition, fabric and home care product, preferably laundry cleaning composition, a laundry treatment product or laundry care product or laundry washing product, more preferably liquid laundry detergent formulation or liquid laundry detergent product, containing at least one block copolymer of the invention and/or at least one block copolymer obtained or obtainable by the inventive process, such composition or product preferably exhibiting improved greying inhibition properties, additionally comprises at least one enzyme, preferably selected from one or more lipases, hydrolases, amylases, proteases, cellulases, hemicellulases, phospholipases, esterases, pectinases, lactases and peroxidases, and combinations of at least two of the foregoing types.

At least one block copolymer as described herein and/or the at least one block copolymer obtained or obtainable by the inventive process as detailed before is present in said inventive compositions and products at a concentration of from about 0.05% to about 20%, preferably 0.05 to 10%, more preferably from about 0.1% to 8%, even more preferably from about 0.2% to about 6%, and further more preferably from about 0.2% to about 4%, and most preferably in amounts of up to 2%, each in weight % in relation to the total weight of such composition or product, and further including all ranges resulting from selecting any of the lower limits and any of the upper limits and all numbers in between those mentioned; such composition or product may—and preferably does—further comprise from about 1% to about 70% by weight of the composition or product of a surfactant system; said compositions and products to be used as greying inhibitor or anti-greying polymer.

Even more preferably, the compositions or products of the present invention as detailed herein before comprising at least one inventive block copolymer as detailed before and/or at least one block copolymer obtained or obtainable by the inventive process as detailed before, and optionally further comprising at least one surfactant or a surfactant system in amounts from about 1% to about 70% by weight of the composition or product, are those for primary cleaning (i.e. removal of stains) within laundry applications, and may additionally comprise at least one enzyme selected from the list consisting of lipases, hydrolases, amylases, proteases, cellulases, hemicellulases, phospholipases, esterases, pectinases, lactases and peroxidases, and combinations of at least two of the foregoing types of enzymes.

In one preferred embodiment, the cleaning composition of the present invention is a liquid or solid laundry detergent composition, preferably a liquid laundry detergent composition.

In one embodiment, the inventive block copolymers may be utilized in cleaning compositions or products comprising C₁₀-C₁₅ alkyl benzene sulfonates (LAS), alcohol ethoxysulphates (AES) or fatty alcohol polyoxyethylene ether, and one or more additional surfactants selected from non-ionic, cationic, amphoteric, zwitterionic or other anionic surfactants, or mixtures thereof.

In a further embodiment, the inventive block copolymers may be utilized in the cleaning compositions or fabric and home care product, preferably a laundry cleaning composition, a laundry care product or laundry treatment product or laundry washing product, preferably a liquid laundry detergent formulation or liquid laundry detergent product, comprising C₈-C₁₈ linear or branched alkyl ethersulfates with 1-5 ethoxy-units as the primary surfactant and one or more additional surfactants selected from non-ionic, cationic, amphoteric, zwitterionic or other anionic surfactants, or mixtures thereof.

In a further embodiment the inventive block polymers may be utilized in cleaning compositions or fabric and home care product, preferably a laundry cleaning composition, a laundry care product or laundry washing product, preferably a liquid laundry detergent formulation or liquid laundry detergent product, comprising C₁₂-C₁₈ alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In one embodiment of the present invention, the block polymer is a component of a cleaning compositions or fabric and home care product, preferably a laundry cleaning composition, a laundry care product or laundry treatment product or laundry washing product, preferably a liquid laundry detergent formulation or liquid laundry detergent product, that each additionally comprise at least one surfactant, preferably at least one anionic surfactant.

The selection of the additional surfactants in these embodiments may be dependent upon the application and the desired benefit.

The cleaning compositions of the invention may be in any form, namely, in the form of a “liquid” composition including liquid-containing composition types such as paste, gel, emulsion, foam and mousse; a solid composition such as powder, granules, micro-capsules, beads, noodles, pearlized balls, agglomerates, tablets, granular compositions, sheets, pastilles, beads, fibrous articles, bars, flakes; or a mixture thereof; types delivered in single-, udal- or multi-compartment pouches or containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof.

Non-limiting examples of “liquids” or“liquid compositions” include light duty and heavy duty liquid detergent compositions, fabric enhancers, detergent gels commonly used for laundry, bleach and laundry additives. Gases, e.g., suspended bubbles, or solids, e.g. particles, may be included within the liquids.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPa*s and most preferably from 500 to 3000 mPa*s at 20 1/s and 20° C.; liquid laundry cleaning compositions have a viscosity of preferably from 50 to 3000 mPa*s, more preferably from 100 to 1500 mPa*s and most preferably from 200 to 1000 mPa*s at 20 1/s and 20° C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25° C. For example, NaOH may be used and the actual weight % of NaOH may be varied and trimmed up to the desired pH such as pH 8.0. In one embodiment of the present invention, a pH>7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use.

One aspect of the present invention is also the use of the inventive polymers as additives for detergent formulations, particularly for liquid detergent formulations, preferably concentrated liquid detergent formulations, or single mono doses for laundry.

The cleaning compositions of the invention may and preferably do contain adjunct cleaning additives (also abbreviated herein as “adjuncts”), such adjuncts being preferably in addition to a surfactant system as defined before.

Suitable adjunct cleaning additives include builders, cobuilders, a surfactant system, fatty acids and/or salts thereof, structurants, thickeners and rheology modifiers, clay/soil removal/anti-redeposition agents, polymeric soil release agents, dispersants such as polymeric dispersing agents, polymeric grease cleaning agents, solubilizing agents, amphiphilic copolymers (including those that are free of vinyl pyrrolidone), chelating agents, enzymes, enzyme stabilizing systems, encapsulated benefit agents such as encapsulated perfume, bleaching compounds, bleaching agents, bleach activators, bleach catalysts, catalytic materials, brighteners, malodor control agents, pigments, dyes, opacifiers, pearlescent agents, hueing agents, dye transfer inhibiting agents, fabric softeners, carriers, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial and antimicrobial agents, preservatives, anti-oxidants, softeners, carriers, fillers, solvents, processing aids, pro-perfumes, and perfumes.

The adjunct(s) may be present in the composition at levels suitable for the intended use of the composition. Typical usage levels range from as low as 0.001% by weight of composition for adjuncts such as optical brighteners to 50% by weight of composition for builders.

Liquid cleaning compositions additionally may comprise besides a surfactant system and block polymer and preferably do comprise at least one of rheology control/modifying agents, emollients, humectants, skin rejuvenating actives, and solvents.

Solid compositions additionally may comprise—and preferably do comprise at least one of—fillers, bleaches, bleach activators and catalytic materials.

Suitable examples of such cleaning adjuncts and levels of use are found in WO 99/05242, U.S. Pat. Nos. 5,576,282, 6,306,812 B1 and 6,326,348 B1.

Those of ordinary skill in the art will understand that a detersive surfactant encompasses any surfactant or mixture of surfactants that provide cleaning, stain removing, or laundering benefit to soiled material.

Hence, the cleaning compositions of the invention such as fabric and home care products, and formulations for industrial and institutional cleaning, more specifically such as laundry and manual dish wash detergents, preferably additionally comprise a surfactant system and, more preferably, also further adjuncts, as the one described above and below in more detail.

The surfactant system may be composed from one surfactant or from a combination of surfactants selected from anionic surfactants, non-ionic surfactants, cationic surfactants, zwitterionic surfactants, amphoteric surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system (specifically detersive surfactant system) in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, non-ionic surfactants, cationic surfactants, zwitterionic surfactants, amphoteric surfactants, and mixtures thereof.

### Laundry Compositions

In laundry formulations, anionic surfactants contribute usually by far the largest share of surfactants within such formulation. Hence, preferably, the inventive cleaning compositions for use in laundry comprise at least one anionic surfactant and optionally further surfactants selected from any of the surfactants classes described herein, preferably from non-ionic surfactants and/or amphoteric surfactants and/or zwitterionic surfactants and/or cationic surfactants.

Nonlimiting examples of anionic surfactants—which may be employed also in combinations of more than one surfactant—useful herein include C₉-C₂₀ linear alkylbenzenesulfonates (LAS), C₁₀-C₂₀ primary, branched chain and random alkyl sulfates (AS); C₁₀-C₁₈ secondary (2,3) alkyl sulfates; C₁₀-C₁₈ alkyl alkoxy sulfates (AExS) wherein x is from 1 to 30; C₁₀-C₁₈ alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS). Preferred examples of suitable anionic surfactants are alkali metal and ammonium salts of C₈-C₁₂-alkyl sulfates, of C₁₂-C₁₈-fatty alcohol ether sulfates, of C₁₂-C₁₈-fatty alcohol polyether sulfates, of sulfuric acid half-esters of ethoxylated C₄-C₁₂-alkylphenols (ethoxylation: 3 to 50 mol of ethylene oxide/mol), of C₁₂-C₁₈-alkylsulfonic acids, of C₁₂-C₁₈ sulfo fatty acid alkyl esters, for example of C₁₂-C₁₈ sulfo fatty acid methyl esters, of C₁₀-C₁₈-alkylarylsulfonic acids, preferably of n-C₁₀-C₁₈-alkylbenzene sulfonic acids, of C₁₀-C₁₈ alkyl alkoxy carboxylates and of soaps such as for example C₈-C₂₄-carboxylic acids. Preference is given to the alkali metal salts of the aforementioned compounds, particularly preferably the sodium salts.

In one embodiment of the present invention, anionic surfactants are selected from n-C₁₀-C₁₃-alkylbenzene sulfonic acids and from fatty alcohol polyether sulfates, which, within the context of the present invention, are in particular sulfuric acid half-esters of ethoxylated C₁₂-C₁₈-alkanols (ethoxylation: 1 to 50 mol of ethylene oxide/mol), preferably of n-C₁₂-C₁₈-alkanols.

In one embodiment of the present invention, also alcohol polyether sulfates derived from branched (i.e., synthetic) C₁₁-C₁₈-alkanols (ethoxylation: 1 to 50 mol of ethylene oxide/mol) may be employed.

Preferably, the alkoxylation group of both types of alkoxylated alkyl sulfates, based on C₁₂-C₁₈-fatty alcohols or based on branched (i.e. synthetic) C₁₁-C₁₈-alcohols, is an ethoxylation group and an average ethoxylation degree of any of the alkoxylated alkyl sulfates is 1 to 5, preferably 1 to 3.

Preferably, the laundry detergent formulation of the present invention comprises from at least 1 wt % to 50 wt %, preferably in the range from greater than or equal to about 2 wt % to equal to or less than about 30 wt %, more preferably in the range from greater than or equal to 3 wt % to less than or equal to 25 wt %, and most preferably in the range from greater than or equal to 5 wt % to less than or equal to 25 wt % of one or more anionic surfactants as described above, based on the particular overall composition, including other components and water and/or solvents.

In a preferred embodiment of the present invention, anionic surfactants are selected from C₁₀-C₁₅ linear alkylbenzenesulfonates, C₁₀-C₁₈ alkylethersulfates with 1-5 ethoxy units and C₁₀-C₁₈ alkylsulfates.

Non-limiting examples of non-ionic surfactants—which may be employed also in combinations of more than one other surfactant—include: C₈-C₁₈ alkyl ethoxylates, such as, NEODOL® non-ionic surfactants from Shell; ethylenoxide/propylenoxide block alkoxylates as PLURONIC® from BASF; C₁₄-C₂₂ mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides). Examples of (additional) amphoteric surfactants are so-called amine oxides.

Preferred examples of alkoxylated alcohols and alkoxylated fatty alcohols are, for example, compounds of the general formula (A)

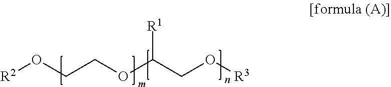

in which the variables are defined as follows:
R¹ is selected from linear C₁-C₁₀-alkyl, preferably ethyl and particularly preferably methyl,
R² is selected from C₈-C₂₂-alkyl, for example n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one. Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

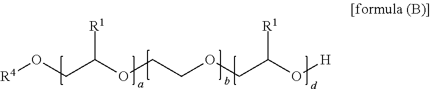

in which the variables are defined as follows:
R¹ is identical or different and selected from linear C₁-C₄-alkyl, preferably identical in each case and ethyl and particularly preferably methyl,
R⁴ is selected from C₆-C₂₀-alkyl, in particular n-C₈H₁₇, n-C₁₀H₂₁, n-C₁₂H₂₅, n-C₁₄H₂₉, n-C₁₆H₃₃, n-C₁₈H₃₇,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EP-A 0 851 023 and in DE-A 198 19 187.

Mixtures of two or more different non-ionic surfactants may of course also be present. In a preferred embodiment of the present invention, non-ionic surfactants are selected from C12/14 and C16/18 fatty alkoholalkoxylates, C13/15 oxoalkoholalkoxylates, C13-alkoholalkoxylates, and 2-propylheptylalkoholalkoxylates, each of them with 3-15 ethoxy units, preferably 5-10 ethoxy units, or with 1-3 propoxy- and 2-15 ethoxy units.

Non-limiting examples of amphoteric surfactants—which may be employed also in combinations of more than one other surfactant—include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred examples of amphoteric surfactants are amine oxides. Preferred amine oxides are alkyl dimethyl amine oxides or alkyl amido propyl dimethyl amine oxides, more preferably alkyl dimethyl amine oxides and especially coco dimethyl amino oxides. Amine oxides may have a linear or mid-branched alkyl moiety. Typical linear amine oxides include water-soluble amine oxides containing one R¹=C₈₋₁₈, alkyl moiety and two R² and R³ moieties selected from the group consisting of C₁-C₃ alkyl groups and C₁-C₃ hydroxyalkyl groups. Preferably, the amine oxide is characterized by the formula

R¹—N(R²)(R³)—O

wherein R¹ is a C₈₋₁₈ alkyl and R² and R³ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₃ alkyl dimethyl amine oxides and linear C₈-C₁₂ alkoxy ethyl dihydroxy ethyl amine oxides. Preferred amine oxides include linear C₁₀, linear C₁₀-C₁₂, and linear C₁₂-C₁₄ alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the alpha carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that (n1-n2) is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C₁-C₃ alkyl, a C₁-C₃ hydroxyalkyl group, or a polyethylene oxide group containing an average of from about 1 to about 3 ethylene oxide groups. Preferably the two moieties are selected from a C₁-C₃ alkyl, more preferably both are selected as a C₁ alkyl.

In a preferred embodiment of the present invention, amphoteric surfactants are selected from C₈-C₁₈ alkyl-dimethyl aminoxides and C₈-C₁₈ alkyl-di(hydroxyethyl)aminoxide.

Cleaning compositions may also contain zwitterionic surfactants—which may be employed also in combinations of more than one other surfactant.

Suitable zwitterionic surfactants include betaines, such as alkyl betaines, alkylamidobetaine, amidazoliniumbetaine, sulfobetaine (INCI Sultaines) as well as the phosphobetaines. Examples of suitable betaines and sulfobetaines are the following (designated in accordance with INCI): Almond amidopropyl of betaines, Apricotamidopropyl betaines, Avocadamidopropyl of betaines, Babassuamidopropyl of betaines, Behenamidopropyl betaines, Behenyl of betaines, Canol amidopropyl betaines, Capryl/Capramidopropyl betaines, Carnitine, Cetyl of betaines, Cocamidoethyl of betaines, Cocamidopropyl betaines, Cocamidopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucamidopropyl Hydroxysultaine, Hydrogenated Tallow of betaines, Isostearamidopropyl betaines, Lauramidopropyl betaines, Lauryl of betaines, Lauryl Hydroxysultaine, Lauryl Sultaine, Milkamidopropyl betaines, Minkamidopropyl of betaines, Myristamidopropyl betaines, Myristyl of betaines, Oleamidopropyl betaines, Oleamidopropyl Hydroxysultaine, Oleyl of betaines, Olivamidopropyl of betaines, Palmamidopropyl betaines, Palmitamidopropyl betaines, Palmitoyl Carnitine, Palm Kernelamidopropyl betaines, Polytetrafluoroethylene Acetoxypropyl of betaines, Ricinoleam idopropyl betaines, Sesamidopropyl betaines, Soyamidopropyl betaines, Stearamidopropyl betaines, Stearyl of betaines, Tallowamidopropyl betaines, Tallowamidopropyl Hydroxysultaine, Tallow of betaines, Tallow Dihydroxyethyl of betaines, Undecylenamidopropyl betaines and Wheat Germamidopropyl betaines.

Preferred betaines are, for example, C₁₂-C₁₈-alkylbetaines and sulfobetaines. The zwitterionic surfactant preferably is a betaine surfactant, more preferable a Cocoamidopropylbetaine surfactant.

Non-limiting examples of cationic surfactants—which may be employed also in combinations of more than one other surfactant—include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Compositions according to the invention may comprise at least one builder. In the context of the present invention, no distinction will be made between builders and such components elsewhere called “co-builders”. Examples of builders are complexing agents, hereinafter also referred to as complexing agents, ion exchange compounds, dispersing agents, scale inhibiting agents and precipitating agents. Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates include alkali metal carbonates and alkali metal hydrogen carbonates, preferred are the sodium salts. Particularly preferred is Na₂CO₃.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylene diaminetetramethylenephosphonate (EDTMP), diethylenetriaminepenta-methylenephosphonate (DTPMP), and also their higher homologues. They are preferably used in the form of the neutrally reacting sodium salts, e.g. as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na₂Si₂O₅, β-Na₂Si₂O₅, and δ-Na₂Si₂O₅.

Compositions according to the invention may contain one or more builder selected from materials not being mentioned above. Examples of builders are α-hydroxypropionic acid and oxidized starch.

In one embodiment of the present invention, builder is selected from polycarboxylates. The term “polycarboxylates” includes non-polymeric polycarboxylates such as succinic acid, C₂-C₁₆-alkyl disuccinates, C₂-C₁₆-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid and its alkali metal salts, in particular its sodium salt, (meth)acrylic acid homopolymers and (meth)acrylic acid copolymers and their alkali metal salts, in particular their sodium salts.

Suitable co-monomers are monoethylenically unsaturated dicarboxylic acids such as maleic acid, fumaric acid, maleic anhydride, itaconic acid and citraconic acid. A suitable polymer is in particular polyacrylic acid, which preferably has a weight-average molecular weight M_{w} in the range from 2000 to 40 000 g/mol, preferably 2000 to 10 000 g/mol, in particular 3000 to 8000 g/mol. Further suitable copolymeric polycarboxylates are in particular those of acrylic acid with methacrylic acid and of acrylic acid or methacrylic acid with maleic acid and/or fumaric acid or anhydrides thereof such as maleic anhydride. Suitable copolymers are in particular copolymers of acrylic acid and maleic acid of a weight average molecular weight Mw in the range of 2000 to 100000, preferably 3000 to 80000.

The preferred weight-average molecular weight Mw of the polyaspartic acid lies in the range between 1000 g/mol and 20 000 g/mol, preferably between 1500 and 15 000 g/mol and particularly preferably between 2000 and 10 000 g/mol.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified co-monomer as listed below.

Suitable hydrophobic co-monomers are, for example, isobutene, diisobutene, butene, pentene, hexene and styrene, olefins with ten or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂—α-olefin, a mixture of C₂₀-C₂₄-α-olefins and polyisobutene having on average 12 to 100 carbon atoms per molecule.

Suitable hydrophilic co-monomers are monomers with sulfonate or phosphonate groups, and also non-ionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Further suitable oligomeric or polymeric polycarboxylates comprise graft polymers of (meth)acrylic acid or maleic acid onto polysaccharides such as degraded starch, carboxymethylated polysaccharides such as carboxymethylated cellulose, carboxymethylated inulin or carboxymethylated starch or polyepoxysuccinic acid and their alkali metal salts, in particular their sodium salts.

Moreover, amphoteric polymers can also be used as builders.

Compositions according to the invention can comprise, for example, in the range from in total 0.1 to 90% by weight, preferably 5 to 80% by weight, preferably up to 70% by weight, of builder(s), especially in the case of solid formulations. Liquid formulations according to the invention preferably comprise in the range of from 0.1 to 20% by weight of builder, such as up to 85, 75, 65, 60, 55, 50, 45, 40, 35, 30, 35, 15, or 10% by weight.

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH>7 is adjusted by using amines, preferably alkanolamines, more preferably triethanolamine.

In one embodiment, the composition according to the present invention comprises additionally at least one enzyme.

Preferably, the at least one enzyme is a detergent enzyme.

In one embodiment, the enzyme is classified as an oxidoreductase (EC 1), a transferase (EC 2), a hydrolase (EC 3), a lyase (EC 4), an isomerase (EC 5), or a ligase (EC 6) (the EC-numbering is according to Enzyme Nomenclature, Recommendations (1992) of the Nomenclature Committee of the International Union of Biochemistry and Molecular Biology including its supplements published 1993-1999). Preferably, the enzyme is a hydrolase (EC 3).

In a preferred embodiment, the enzyme is selected from the group consisting of proteases, amylases, lipases, cellulases, mannanases, hemicellulases, phospholipases, esterases, pectinases, lactases, peroxidases, xylanases, cutinases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, nucleases, DNase, phosphodiesterases, phytases, carbohydrases, galactanases, xanthanases, xyloglucanases, oxidoreductase, perhydrolases, aminopeptidase, asparaginase, carbohydrase, carboxypeptidase, catalase, chitinase, cyclodextrin glycosyltransferase, alpha-galactosidase, beta-galactosidase, glucoamylase, alpha-glucosidase, beta-glucosidase, invertase, ribonuclease, transglutaminase, and dispersins, and combinations of at least two of the foregoing types. More preferably, the enzyme is selected from the group consisting of proteases, amylases, lipases, cellulases, mannanases, xylanases, DNases, dispersins, pectinases, oxidoreductases, and cutinases, and combinations of at least two of the foregoing types. Most preferably, the enzyme is a protease, preferably, a serine protease, more preferably, a subtilisin protease.

Such enzyme(s) can be incorporated into the composition at levels sufficient to provide an effective amount for achieving a beneficial effect, preferably for primary washing effects and/or secondary washing effects, like antigreying or antipilling effects (e.g., in case of cellulases).

Preferably, the enzyme is present in the composition at levels from about 0.00001% to about 5%, preferably from about 0.00001% to about 2%, more preferably from about 0.0001% to about 1%, or even more preferably from about 0.001% to about 0.5% enzyme protein by weight of the composition.

Preferably, the enzyme-containing composition further comprises an enzyme stabilizing system.

Preferably, the enzyme-containing composition described herein comprises from about 0.001% to about 10%, from about 0.005% to about 8%, or from about 0.01% to about 6%, by weight of the composition, of an enzyme stabilizing system. The enzyme stabilizing system can be any stabilizing system which is compatible with the enzyme.

Preferably, the enzyme stabilizing system comprises at least one compound selected from the group consisting of polyols (preferably, 1,3-propanediol, ethylene glycol, glycerol, 1,2-propanediol, or sorbitol), salts (preferably, CaCl₂, MgCl₂, or NaCl), short chain (preferably, C₁-C₆) carboxylic acids (preferably, formic acid, formate (preferably, sodium formate), acetic acid, acetate, or lactate), borate, boric acid, boronic acids (preferably, 4-formyl phenylboronic acid (4-FPBA)), peptide aldehydes, peptide acetals, and peptide aldehyde hydrosulfite adducts. Preferably, the enzyme stabilizing system comprises a combination of at least two of the compounds selected from the group consisting of salts, polyols, and short chain carboxylic acids and preferably one or more of the compounds selected from the group consisting of borate, boric acid, boronic acids (preferably, 4-formyl phenylboronic acid (4-FPBA)), peptide aldehydes, peptide acetals, and peptide aldehyde hydrosulfite adducts. In particular, if proteases are present in the composition, protease inhibitors may be added, preferably selected from borate, boric acid, boronic acids (preferably, 4-FPBA), peptide aldehydes (preferably, peptide aldehydes like Z-VAL-H or Z-GAY-H), peptide acetals, and peptide aldehyde hydrosulfite adducts.

Compositions according to the invention may comprise one or more bleaching agent (bleaches).

Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H₂SO₅ and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylene diamine, tetraacetylglycoluril, tetraacetylhexylene diamine, acylated phenolsulfonates such as for example n-nonanoyl- or isononanoyloxybenzene sulfonates, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention may also comprise further cleaning polymers and/or other soil release polymers and/or anti-greying polymers.

The additional cleaning polymers may include, without limitation, “multifunctional polyethylene imines” (for example BASF's Sokalan© HP20) and/or “multifunctional diamines” (for example BASF's Sokalan® HP96). Such multifunctional polyethylene imines are typically ethoxylated polyethylene imines with a weight-average molecularweight M_{w} in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional polyethylene imines have 80 wt % to 99 wt %, preferably 85 wt % to 99 wt %, more preferably 90 wt % to 98 wt %, most preferably 93 wt % to 97 wt % or 94 wt % to 96 wt % ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight M_{W} in the range of 500 to 5000 g/mol. Preferably employed is a molecular weight from 500 to 1000 g/mol, even more preferred is a M_{W} of 600 to 800 g/mol. The ethoxylated polymer then has on average 5 to 50, preferably 10 to 35 and even more preferably 20 to 35 ethylene oxide (EO) units per NH-functional group.

Suitable multifunctional diamines are typically ethoxylated C₂ to C₁₂ alkylene diamines, preferably hexamethylene diamine, which are further quaternized and optionally sulfated. Typical multifunctional diamines have a weight-average molecular weight M_{w} in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

Laundry formulations comprising the inventive polymer may also comprise at least one complexing agent.

Preferred complexing agents are methylglycinediacetic acid (MGDA) and glutamic acid diacetic acid (GLDA) and salts thereof. Particularly preferred complexing agents are methylglycinediacetic acid and salts thereof. According to the invention, preference is given to 1 to 50% (würde ich reduzieren auf 20 Gew. %) by weight of complexing agents.

MGDA and GLDA can be present as racemate or as enantiomerically pure compound. GLDA is preferably selected from L-GLDA or enantiomerically enriched mixtures of L-GLDA in which at least 80 mol %, preferably at least 90 mol %, of L-GLDA is present.

In one embodiment of the present invention, complexing agent is racemic MGDA. In another embodiment of the present invention, complexing agent is selected from L-MGDA and from enantiomer mixtures of L- and D-MGDA in which L-MGDA predominates and in which the L/D molar ratio is in the range from 55:45 to 95:5, preferably 60:40 to 85:15. The L/D molar ratio can be determined for example by polarimetry or by chromatographic means, preferably by HPLC with a chiral column, for example with cyclodextrin as stationary phase or with an optically active ammonium salt immobilized on the column. For example, it is possible to use an immobilized D-penicillamine salt.

MGDA or GLDA is preferably used as the salt. Preferred salts are ammonium salts and alkali metal salts, particularly preferably the potassium and in particular the sodium salts. These can for example have the general formula (CA I) or (CA II):

[CH₃—CH(COO)—N(CH₂—COO)₂]Na_{3-x-y} KₓH_{y} (CA I)
x in the range from 0.0 to 0.5, preferably up to 0.25,
y in the range from 0.0 to 0.5, preferably up to 0.25,

[OOC—(CH₂)₂—CH(COO)—N(CH₂—COO)₂]Na_{4-x-y}KₓH_{y} (CA II)
x in the range from 0.0 to 0.5, preferably up to 0.25,
y in the range from 0.0 to 0.5, preferably up to 0.25.

Very particular preference is given to the trisodium salt of MGDA and the tetrasodium salt of GLDA.

The detergent formulations comprising the inventive polymer may also comprise at least one antimicrobial agent and/or preservative.

An antimicrobial agent is a chemical compound that kills microorganisms or inhibits their growth or reproduction. Microorganisms can be bacteria, yeasts or molds.

A preservative is an antimicrobial agent which may be added to aqueous products and compositions to maintain the original performance, characteristics and integrity of the products and compositions by killing contaminating microorganisms or inhibiting their growth. Examples of preservatives are as listed on pages 35 to 39 in patent application WO2021/115912 A1.

Especially of interest are the following antimicrobial agents and/or preservatives:
4,4′-dichloro-2-hydroxydiphenyl ether (Synonyms: 5-chloro-2-(4-chlorophenoxy) phenol, Diclosan, DCPP);
2-Phenoxyethanol (Synonyms: Phenoxyethanol, Methylphenylglycol, Phenoxetol, ethylene glycol phenyl ether, Ethylene glycol monophenyl ether, 2-(phenoxy)ethanol, 2-phenoxy-1-ethanol);
2-bromo-2-nitropropane-1,3-diol (Synonyms: 2-bromo-2-nitro-1,3-propanediol, Bronopol);
Glutaraldehyde (Synonyms: 1-5-pentandial, pentane-1,5-dial, glutaral, glutardialdehyde);
Glyoxal (Synonyms: ethandial, oxylaldehyde, 1,2-ethandial);
2-butyl-benzo[d]isothiazol-3-one (BBIT);
2-methyl-2H-isothiazol-3-one (MIT);
2-octyl-2H-isothiazol-3-one (OIT);
5-Chloro-2-methyl-2H-isothiazol-3-one (CIT or CMIT);
Mixture of 5-chloro-2-methyl-2H-isothiazol-3-one (CMIT) and 2-methyl-2H-isothiazol-3-one (MIT) (Mixture of CMIT/MIT);
1,2-benzisothiazol-3(2H)-one (BIT);
Hexa-2,4-dienoic acid (trivial name “sorbic acid”) and its salts, e.g., calcium sorbate, sodium sorbate; potassium (E,E)-hexa-2,4-dienoate (Potassium Sorbate);
Lactic acid and its salts; L-(+)-lactic acid; especially sodium lactate;
Benzoic acid and salts of benzoic acid, e.g., sodium benzoate, ammonium benzoate, calcium benzoate, magnesium benzoate, MEA-benzoate, potassium benzoate;
Salicylic acid and its salts, e.g., calcium salicylate, magnesium salicylate, MEA salicylate, sodium salicylate, potassium salicylate, TEA salicylate;
Benzalkonium chloride, benzalkonium bromide, benzalkonium saccharinate;
Didecyldimethylammonium chloride (DDAC);
N-(3-aminopropyl)-N-dodecylpropane-1,3-diamine (Diamine);
Peracetic acid; and
Hydrogen peroxide.

The at least one antimicrobial agent or preservative may be added in the detergent composition in an amount of 0.0001 to 10% based on the total weight of the composition.

Preferably, the detergent composition comprises 2-phenoxyethanol in an amount of 2 ppm to 5%, preferably 0.1 to 2%, or 4,4′-dichloro 2-hydroxydiphenyl ether (DCPP) in an amount of 0.001 to 3%, preferably 0.002 to 1%, more preferably 0.01 to 0.6%, based on the total weight of the composition.

Formulations according to the invention may also comprise water and/or additional organic solvents, e.g., ethanol or propylene glycol, and/or fillers such as sodium sulfate.

Further optional ingredients may be but are not limited to viscosity modifiers, cationic surfactants, foam boosting or foam reducing agents, perfumes, dyes, optical brighteners, and dye transfer inhibiting agents.

### EXAMPLES

### Polymer Measurement

The number average molecular weight (Mₙ) of the inventive block polymer and the block B were determined by Gel permeation chromatography (GPC). GPC was performed through three PSS SDV columns equipped with a refractive index detector. Tetrahydrofuran was used as the eluent at a flow rate of 1.0 mL/min at 35° C. and a DRI Agilent 1100 was used as the detection system. Polystyrene standards were used for calibration.

The number average molecular weight (MO of the block A of the inventive polymer was determined by NMR.

The number average molecular weight (Mₙ) ratio of the block B to the block A was measured and calculated by nuclear magnetic resonance (NMR), based on integrations of the characteristic resonance signals of the methylene protons of the EO units at 3.25-3.83 ppm and the characteristic signals of Polyvinyl Acetate (PVAc) at 1.80, 2.14, 4.91 ppm.

### Method for Measuring Polymer Biodegradability

Biodegradation in wastewater was tested in triplicate using the OECD 301F manometric respirometry method. 30 mg/mL test substance is inoculated into wastewater taken from Mannheim Wastewater Treatment Plant and incubated in a closed flask at 25° C. for 28 days. The consumption of oxygen during this time is measured as the change in pressure inside the flask using an OxiTop C (WTW). Evolved CO2 is absorbed using an NaOH solution. The amount of oxygen consumed by the microbial population during biodegradation of the test substance, after correction using a blank, is expressed as a % of the ThOD (Theoretical Oxygen Demand).

### Polymer Preparation

### Example 1

### 2-((Ethoxycarbonothioyl)thio)acetic acid

A solution of 2-bromoacetic acid (38.35 g, 276 mmol) in distilled water (200 mL) was cooled to 0° C. Potassium o-ethylxanthate (48.67 g, 304 mmol) was added dropwise over two hours. The reactor was slowly warmed up to room temperature and the mixture was stirred for 6 hours. The reaction mixture was then cooled down to 0° C. and kept at 2-8° C. overnight. The crystals were then filtered, washed with cold water and dried above filtration paper in a crystallizer to afford the desired product, which could be recrystallized from ethyl acetate/n-hexane (1:10) to give the desired product as acicular crystals (36 g, 73% yield).

### Synthesis of Macro-Chain Transfer Agent:

Firstly, PEG-OH (4500 Da, 18.2 g, 4 mmol for −OH (Hydroxy) terminal) and 2-((Ethoxycarbonothioyl)thio)acetic acid(3.6 g, 20 mmol) were dissolved in dichloromethane (DCM) (80 mL) and stirred with 4-dimethylaminopyridine (DMAP) (0.245 g, 2 mmol) at 0° C. Secondly, dicyclohexyl-carbodiimide (DCC) (4.1 g, 20 mmol, in 20 mL DCM) was added into the solution dropwise in 30 mins. The mixture was stirred at room temperature for 24 h. Then, DCM (100 mL) and basic alumina (10 g) were added, and the reaction mixture was kept stirring at room temperature for 15 mins. After the undissolved substance was removed by filtration, the obtained solution was washed using saturated sodium bicarbonate (2*50 mL), water (2*50 mL), and dried over anhydrous magnesium sulfate. At last, the solvent was evaporated under vacuum, and the resulting powder was precipitated from cold diethyl ether. 14.4 g of PEG-XAN (polyethylene glycol with dithiocarbonate (xanthate) end-group) was obtained (79% recovery). ¹H NMR indicated quantitative conversion of the end groups.

### Synthesis of Block Copoly(Vinyl Acetate-Ethylene Oxide) by RAFT Polymerization

Vinyl acetate (VAc) (21.5 g, 250 mmol), azobis-isobutyronitrile AlBN (100.0 mg), PEG-XAN (9.1 g, 2 mmol, for -xanthate end group), and tetrahydrofuran (THF) (40 mL) were placed in a Schlenk tube and degassed via freeze-pump-thaw cycles followed by the introduction of argon. The flask was immersed in an oil bath preheated at 60° C. After 12 h, 16.5 g of diblock copolymer was isolated by precipitation in cold petroleum ether. The molecular weight and comonomer ratio were detected by ¹H NMR and GPC.

The obtained block copolymer of Example 1 is diblock copolymer of poly(vinyl acetate-b-ethylene oxide).

### Polymer Characterization of Example 1

The number average of molecular weight (Mₙ) of the block copolymer measured by GPC: 6470 g/mol

The number average of molecular weight (Mₙ) of the block B (polyethylene oxide) measured by GPC: 3600 g/mol.

The number average of molecular weight (Mₙ) of the block A (Polyvinyl acetate) measured by NMR: 4900 g/mol.

The degree of polymerization (DP) of the block B is 102 and the degree of polymerization (DP) of the block A is 57.

The Mₙ ratio of the block B to the block A is 0.73:1

### Example 2

### Synthesis of Macro-Chain Transfer Agent: Xan-PEO 6050-Xan

Firstly, OH-PEG-OH (6050 Da, 18.2 g, 6 mmol for —OH group) and 2-((Ethoxycarbonothioyl)thio)acetic acid (5.4 g, 30 mmol), prepared according to Example 1, were dissolved in DCM (120 mL) and stirred with 4-dimethylaminopyridine (0.367 g, 3 mmol) at 0° C. Secondly, dicyclohexylcarbodiimide (6.2 g, 30 mmol, in 30 mL DCM) was added into the solution dropwise in 25 mins. The mixture was stirred at room temperature for 24 h. Then, DCM (100 mL) and basic alumina (10 g) were added, and the reaction mixture was kept stirring at room temperature for 15 mins. After the undissolved substance was removed by filtration, the obtained solution was washed using saturated sodium bicarbonate (2*50 mL), water (2*50 mL), and dried over anhydrous magnesium sulfate. At last, the solvent was evaporated under vacuum, and the resulting powder was precipitated from cold diethyl ether. 15.6 g of PEG-XAN (polyethylene glycol with dithiocarbonate (xanthate) end-group) was obtained (86% recovery). ¹H NMR indicated quantitative conversion of the end groups.

Synthesis of block poly(Vinyl acetate-ethylene oxide-vinyl acetate) by RAFT polymerization VAc (18.9 g, 220 mmol), AIBN (100.0 mg), PEG-XAN (6 g, 2 mmol, for -XAN), and THF (40 mL) were placed in a Schlenk tube and degassed via freeze-pump-thaw cycles followed by the introduction of argon. The flask was immersed in an oil bath preheated at 60° C. After 10 h, 10.6 g of triblock copolymer was isolated by precipitation in cold petroleum ether. The molecular weight and comonomer ratio were detected by ¹H NMR and GPC.

The obtained block copolymer of Example 2 is triblock copolymer of poly(vinyl acetate-b-ethylene oxide-b-vinyl acetate).

### Polymer Characterization of Example 2

The number average of molecular weight (Mₙ) of the block copolymer measured by GPC: 7990 g/mol

The number average of molecular weight (Mₙ) of the block B (polyethylene oxide) measured by GPC: 4280 g/mol.

The number average of molecular weight (Mₙ) of the block A (Polyvinyl acetate) measured by NMR: 5400 g/mol

The degree of polymerization (DP) of the block B is 136 and the degree of polymerization (DP) of the block A is 62.

The Mₙ ratio of the block B to the block A is 0.79:1

### Example 3

Macro-Chain transfer agent was prepared according to Example 2, followed by the synthesis of poly(VAc-EO-VAc) by RAFT polymerization, as follows: VAc (22.5 g, 260 mmol), AIBN (100.0 mg), PEG-XAN (6 g, 2 mmol, for xanthate end group), and THF (40 mL) were placed in a Schlenk tube and degassed via freeze-pump-thaw cycles followed by the introduction of argon. The flask was immersed in an oil bath preheated at 60° C. After 12 h, 13.1 g of triblock copolymer was isolated by precipitation in cold petroleum ether. The molecular weight and comonomer ratio were detected by 1H NMR and GPC.

The obtained block copolymer of Example 3 is triblock copolymer of poly(vinyl acetate-b-ethylene oxide-b-vinyl acetate).

### Polymer Characterization of Example 3

The number average of molecular weight (Mₙ) of the block copolymer measured by GPC: 9500 g/mol

The number average of molecular weight (Mₙ) of the block B (polyethylene oxide) measured by GPC: 4280 g/mol

The number average of molecular weight (Mₙ) of the block A (Polyvinyl acetate) measured by NMR: 7042 g/mol

The degree of polymerization (DP) of the block B is 137 and the degree of polymerization (DP) of the block A is 82.

The Mₙ ratio of the block B to the block A is 0.61:1

### Example 4

### Synthesis of Macro-Chain Transfer Agent

OH-PEG-OH (4000 g/mol, 12 g, 6 mmol resp. —OH) and 2-((Ethoxycarbonothioyl)thio)acetic acid (5.4 g, 30 mmol), which was prepared according to Example 1, were dissolved in DCM (100 mL) in a three-neck flask and stirred with DMAP (0.367 g, 3 mmol) at 0 C. DCC (6.2 g, 30 mmol) was dissolved in dichloromethane (20 mL) and added drop-wise in 30 mins. The mixture was stirred at room temperature for 24 h. dichloromethane (100 mL) and basic alumina (10 g) were added. Stirring continued at room temperature for 15 min, then the solid was removed by filtration. The obtained solution was saturated sodium bicarbonate (2*50 mL), water (2*50 mL), and dried over anhydrous magnesium sulfate. The solvents were evaporated under vacuum, and the resulting solid was precipitated from cold diethyl ether. 10.80 g of XAN-PEG-XAN (polyethylene glycol with two xanthate end groups) was obtained (90% recovery). ¹H NMR confirmed quantitative conversion of the end groups.

### Synthesis of Poly(Vinyl Acetate-Ethylene Oxide-Vinyl Acetate) by RAFT Polymerization

Vinyl Acetate (VAc) (2.15 g, 25 mmol), Azobisisobutyronitrile (AIBN) (21.0 mg, 0.125 mmol), XAN-PEG-XAN (5.0 g, 1.25 mmol, respectively -Xanthate end group), and THF (13 mL) were added in a Schlenk tube and degassed via three cycles of freeze-pump-thaw, followed by back-feeding of nitrogen. The flask was then immersed in an oil bath, preheated at 70° C. After 15 h, the resulting triblock copolymer was precipitated in diethyl ether and subsequently filtered off and dried in a vacuum oven at 40° C. for 24 h. The molecular weight and comonomer ratio were detected by 1H NMR and GPC.

The obtained block copolymer of Example 4 is triblock copolymer of poly(vinyl acetate-b-ethylene oxide-b-vinyl acetate).

### Polymer Characterization of Example 4

The number average of molecular weight (Mₙ) of the block copolymer measured by GPC: 7620 g/mol

The number average of molecular weight (Mₙ) of the block B (polyethylene oxide) measured by GPC: 6000 g/mol

The number average of molecular weight (Mₙ) of the block A (Polyvinyl acetate) measured by NMR: 517 g/mol

The degree of polymerization (DP) of the block B is 91 and the degree of polymerization (DP) of the block A is 6.

The Mₙ ratio of the block B to the block A is 11.6:1

### Example 5

Example 5 was prepared in the same manner as Example 4, with the exception that different VAc amount (5.17 g, 60 mmol) was added for the polymerization.

The obtained block copolymer of Example 5 is triblock copolymer of poly(vinyl acetate-b-ethylene oxide-b-vinyl acetate).

### Polymer Characterization of Example 5

The number average of molecular weight (Mₙ) of the block copolymer measured by GPC: 9740 g/mol

The number average of molecular weight (Mₙ) of the block B (polyethylene oxide) measured by GPC: 6000 g/mol

The number average of molecular weight (Mₙ) of the block A (Polyvinyl acetate) measured by NMR: 2755 g/mol

The degree of polymerization (DP) of the block B is 91 and the degree of polymerization (DP) of the block A is 32.

The Mₙ ratio of the block B to the block A is 2.18:1

### Example 6

Example 6 was prepared in the same manner as Example 4, with the exception that different VAc amount (6.89 g, 80 mmol) was added for the polymerization.

The obtained block copolymer of Example 6 is triblock copolymer of poly(vinyl acetate-b-ethylene oxide-b-vinyl acetate).

### Polymer Characterization of Example 6

The number average of molecular weight (Mₙ) of the block A copolymer measured by GPC: 12400 g/mol

The number average of molecular weight (Mₙ) of the block B (polyethylene oxide) measured by GPC: 6000 g/mol

The degree of polymerization (DP) of the block B is 91 and the degree of polymerization (DP) of the block A is 62.

The number average of molecular weight (Mₙ) of the block A (Polyvinyl acetate) measured by NMR: 5338 g/mol

The Mₙ ratio of the block B to the block A is 1.12:1

### Comparative Example 1

OH-PEG-OH (4000 g/mol, 600 g) were heated to 90° C. At this temperature, 400 g of vinylacetate (VAc) were added over 4 hours and a solution of 15 g tert.-butylperoctoate in 45 g n-butylacetate was added over 5 hours. After 3 hours, the product was distilled under vacuum. The molecular weight and comonomer ratio were detected by 1H NMR and GPC.

The obtained copolymer of comparative example 1 is graft copolymer poly(vinyl acetate-g-ethylene oxide).

### Polymer Characterization of Comparative Example 1

The number average of molecular weight (Mₙ) of the graft copolymer measured by GPC: 9960 g/mol

The number average of molecular weight (Mₙ) of polyethylene oxide measured by GPC: 6000 g/mol

The Mₙ ratio of the polyethylene oxide to polyvinyl acetate measured by NMR: 61:39

### Comparative Example 2

OH-PEG-OH (4000 g/mol, 300 g) were heated to 90° C. At this temperature, 500 g of vinylacetate were added over 7 hours and a solution of 10 g tert-butylperoctoate in 24 g dipropylene glycol was added over 8 hours. After 1 hour, the product was distilled under vacuum. The molecular weight and comonomer ratio were detected by 1H NMR and GPC.

The obtained copolymer of comparative example 2 is graft copolymer poly(vinyl acetate-g-ethylene oxide).

### Polymer Characterization of Comparative Example 2

The number average of molecular weight (Mₙ) of the graft copolymer measured by GPC: 7110 g/mol

The number average of molecular weight (Mₙ) of polyethylene oxide measured by GPC: 6000 g/mol

The Mₙ ratio of polyethylene oxide to polyvinyl acetate measured by NMR: 39:61

### Biodegradability

The biodegradability test results are shown in Table 1.

TABLE 1

| | Biodegradability OECD |
|---|---|
| | 301F (28 days) |
| Example 1 | 46% |
| Example 2 | 57% |
| Example 3 | 57% |
| Example 4 | 57% |
| Example 5 | 99% |
| Example 6 | 57% |
| Comparative Example 1 | 19% |
| Comparative Example 2 | 20% |

### Anti-Greying Performance

### Anti-Greying Test 1:

A test soil mixture was prepared by mixing 75% deionized water, 20% yellow clay (JIS Soil), 3.75% peanut oil (Luhua oil, Shandong) and 1.25% mineral oil. Specifically, 20% clay dispersion was first added in the water, stirred at 6,500 rpm for 10 min to homogenize. Then, the mixture of the two oils was slowly added and the whole mixture was homogenized for another 10 min.

A laundering process was simulated in the lab using a Lauder-o-meter (ATLAS M228AA) which includes individual barrels with 20 steel balls for stirring, generally following GBT 13174-2008. The washing units were operated at the same stirring speed of 120 rpm, each containing 200 ml water. White test fabrics were washed in the same barrel together with 0.2 g of the test soil mixture at a specified temperature, in a wash liquor comprising a detergent formulation containing the functional additives as shown in Table 3. After the washing, the fabrics were removed from the washing units, drained and rinsed twice in 10 L tap water for 30 seconds. The wash cycle was repeated two times with new yellow clay and oil mixtures and new wash liquor. After the rinsing in the third wash cycle, the test fabrics were dried. The details of the wash cycles are summarized in Table 2.

The anti-greying performance was characterized by Remission ΔR value, measured with the spectrophotometer Elrepho 2000 from Datacolor at 457 nm. The clean fabric before wash was compared with the washed fabric after wash. The lower the difference in Remission ΔR, the better is the performance. Results are summarized in Table 4.

TABLE 2

| Machine Type | Launder-o-meter, 120 rpm | |
|---|---|---|
| Washing Liquor/g | 200 | |
| Detergent/[g/L] | 3 | g/L |
| Hard Water/[mg CaCO₃/L] | 250 | ppm |

| Ca:Mg Ratio | 3:2 |
|---|---|
| Fabric Type | Polyester woven WFK 30A, Cotton |
| | knitted WFK 80A |
| Fabric Size/cm*cm | 6*6 |
| Fabric Amount/Piece | 8 (4 piece of each type fabric) |
| Stain Type | 10 g/L yellow clay and oil mixtures |
| | (WFK soil oily mixture) |
| Washing Time/min | 30 |
| Washing Temp./° C. | 30 (1^{st} cycle), 80 (2^{nd} cycle) |
| Washing Cycle | 2 |
| Washing Repeat | 1 |
| Rinsing Condition | Tap water directly |
| Dry Condition | Oven 2 h, 50° C. |
| Fabric Measurement | 2^{nd} cycle |

TABLE 3
Detergent formulation

| | |
|---|---|
| Linear C₁₀C₁₃-Alkyl Benzene | 5 |
| sulfonates | |
| (commercially available from | |
| BASF) | |
| C₁₂C₁₄ fatty alcohol ether sulfate | 10 |
| (2EO) | |
| (Commercially available from | |
| BASF) | |
| Ethoxylated C₁₂C₁₄ fatty alcohol | 5 |
| (7 EO) (commercially available | |
| from BASF) | |
| Sodium Citrate | 0.5 |
| Ethanol | 1.5 |
| Na₂SO₄ | 0.2 |
| NaCl | 0.1 |
| Additive | 1 |
| Water | To 100 |

TABLE 4

| Additive | ΔR, Sum of all fabrics |
|---|---|
| Blank | 33.8 |
| Graft polymer of | 24.0 |
| polyethylene oxide (PEO) | |
| and polyvinyl acetate | |
| (PVAc) | |
| Example 1 | 24.9 |
| Example 2 | 21.1 |

Blank: no anti-greying agent/additive was used.
Graft polymer of PEO and PVAc: Mw 30,000 g/mol, solid content 20 wt %, commercially available from BASF.

### Anti-Greying Test 2:

A test soil mixture was prepared according to Test 1. The detergent formulation comprising functional additives are the same as detailed in Table 3. A laundering process was simulated in the lab using a Lauder-o-meter (ATLAS M228AA) which includes individual barrels with 20 steel balls for stirring, generally following GBT 13174-2008. The washing units were operated at the same stirring speed of 120 rpm, each containing 200 ml water. White test fabrics were washed in the same barrel together with 0.2 g of the test soil mixture at 30° C., in a wash liquor comprising a detergent formulation as shown in the table of Test 1. After the washing, the fabrics were removed from the washing units, drained and rinsed twice in 10 L tap water for 30 seconds. The wash cycle was repeated three times with new yellow clay and oil mixtures and new wash liquor. After the rinsing in the third wash cycle, the test fabrics were dried. The details of the wash cycles are summarized in Table 5.

The anti-greying performance was evaluated according to Test 1 and the results are shown in Table 6.

TABLE 5

| Machine Type | Launder-o-meter, 120 rpm | |
|---|---|---|
| Washing Liquor/g | 200 | |
| Detergent/[g/L] | 3 | g/L |
| Hard Water/[mg CaCO₃/L] | 250 | ppm |

| Ca:Mg Ratio | 3:2 |
|---|---|
| Fabric Type | Polyester woven WFK 30A, Cotton |
| | knitted WFK 80A |
| Fabric Size/cm*cm | 6*6 |
| Fabric Amount/Piece | 8 (4 piece of each type fabric) |
| Stain Type | 10 g/L yellow clay and oil mixtures |
| | (WFK soil oily mixture) |
| Washing Time/min | 30 |
| Washing Temp./° C. | 30 |
| Washing Cycle | 3 |
| Washing Repeat | 1 |
| Rinsing Condition | Tap water directly |
| Dry Condition | Oven 2 h, 50° C. |
| Fabric Measurement | 3^{rd} cycle |

TABLE 6

| Additive | ΔR, Sum of all fabrics |
|---|---|
| Blank | 40.1 |
| Graft polymer of | 33.6 |
| polyethylene oxide and | |
| polyvinyl acetate | |
| Example 1 | 34.7 |
| Example 2 | 33.5 |
| Example 3 | 31.5 |

Blank: no anti-greying additive was used.
Graft polymer of PEO and PVAc: Mw 30,000 g/mol, solid content 20 wt %, commercially available from BASF.

### Anti-Greying Test 3:

A test soil mixture was prepared according to Test 1. A laundering process was simulated in the lab using a Tergotometer (RHLQ-IV by RIDCI) which includes individual barrels with respective rotor blades as washing units, generally following GBT 13174-2008. The washing units were operated at the same stirring speed of 120 rpm, each containing 1 L water. White test fabrics were washed in the same barrel together with 10 g of the test soil mixture at 30° C., in a wash liquor comprising a detergent formulation as shown in Table 8. After the washing, the fabrics were removed from the washing units, drained and rinsed twice in 10 L tap water for 30 seconds. The wash cycle was repeated three times with new yellow clay and oil mixtures and new wash liquor. After the rinsing in the third wash cycle, the test fabrics were dried. The details of the wash cycles are summarized in Table 7.

The anti-greying performance was evaluated according to Test 1 and the results are shown in Table 9.

TABLE 7

| Machine Type | Tergotometer, 120 rpm | |
|---|---|---|
| Washing Liquor/g | 1000 | |
| Detergent/[g/L] | 2 | g/L |
| Hard Water/[mg CaCO₃/L] | 250 | ppm |

| Ca:Mg Ratio | 3:2 |
|---|---|
| Fabric Type | Cotton, towel WFK 12A, PES/PO |
| | woven WFK 20A, Polyester woven |
| | WFK 30A, Cotton knitted WFK 80A |
| Fabric Size/cm*cm | 6*6 |
| Fabric Amount/Piece | 15 (3 piece of each type fabric) |
| Stain Type | 10 g/L yellow clay and oil mixtures |
| | (WFK soil oily mixture) |
| Washing Time/min | 30 |
| Washing Temp./° C. | 30 |
| Washing Cycle | 3 |
| Washing Repeat | 1 |
| Rinsing Condition | Haier Mini top-loading machine, max |
| | water level (10 L) |
| Dry Condition | Naturally |
| Fabric Measurement | 3rd cycle |

TABLE 8

| Ingredient | wt. % (active matter) |
|---|---|
| Linear C₁₀C₁₃-Alkyl | 27.5 |
| Benzene sulfonates | |
| (commercially | |
| available from | |
| BASF) | |
| C₁₂C₁₄ fatty alcohol | 10.5 |
| ether sulfate (2EO) | |
| (Commercially | |
| available from | |
| BASF) | |
| Ethoxylated C₁₂C₁₄ | 5 |
| fatty alcohol (7 EO) | |
| (commercially | |
| available from | |
| BASF) | |
| Sodium Citrate | 0.5 |
| Ethanol | 1.5 |
| Additive | 1 |
| Water | To 100 |

TABLE 9

| Additive | ΔR, Sum of all fabrics |
|---|---|
| Blank | 34.8 |
| Graft polymer of polyethylene | 28.2 |
| oxide and polyvinyl acetate | |
| Example 4 | 31.1 |
| Example 5 | 28.5 |
| Example 6 | 27.6 |

Blank: no anti-greying agent was used.
Graft polymer of PEO and PVAc: Mw 30,000 g/mol, solid content 20 wt %, commercially available from BASF.

Compatibility with Biocide in a Liquid Laundry Formulation

Liquid laundry detergent formulations containing 1% by weight of the inventive polymer and/or 0.3% of the biocide Tinosan® HP 100 (from BASF) and/or 1% phenoxyethanol (Protectol® PE, BASF) as shown in Table 10 below were prepared. A premix containing surfactants, solvents, fatty acid, citric acid and NaOH as shown in the Table 10 and water up to 90% was first prepared by adding those components to water and stirring at room temperature, with pH being set to 8.5 with NaOH. Then, a final formulation was prepared by stirring the premix, optionally the polymer and/or the biocide and water up to 100% at room temperature: 90% of this pre-mix, the appropriate concentrations of the present polymer and/or Tinosan® HP 100 (commercial product of BASF SE containing 30% of the antimicrobial active 4,4′-dichoro 2-hydroxydiphenylether) and/or 2-phenoxyethanol and water up 100%.

The appearance of the liquid laundry detergent formulations were evaluated visually. The absorbance is measured using a Hach-Lange DR3900 spectrometer with glass 1-inch cuvette at room temperature. Deionized water is taken to measure the base line. Compositions and results are shown in Table 10.

### Materials:

AEO: C₁₂/C₁₄ fatty alcohol (7EO) Lutensol AO7 (BASF)
AES: Alcohol Ethoxysulfate: Texapon N 70 (BASF).
LAS: Linear alkylbenzene sulfonate Maranil DBS/LC (BASF)
Coco fatty acid: Edenor K12-18 (Emery Oleochemicals)
Tinosan® HP 100: commercial product of BASF SE containing 30% of the antimicrobial active 4,4′-dichoro 2-hydroxydiphenylether
Phenoxyethanol

In the Table 10 the concentrations of the surfactant trade products are given.

TABLE 10

| | A | B | C | D | E | F |
|---|---|---|---|---|---|---|
| Ingredients | (comp.) | (comp.) | (comp.) | (comp.) | (inv.) | (inv.) |
| Non-ionic | 5.4% | 5.4% | 5.4% | 5.4% | 5.4% | 5.4% |
| surfactant | | | | | | |
| AEO-2 | | | | | | |
| Anionic | 7.7% | 7.7% | 7.7% | 7.7% | 7.7% | 7.7% |
| surfactant AES | | | | | | |
| Anionic | 5.5% | 5.5% | 5.5% | 5.5% | 5.5% | 5.5% |
| surfactant LAS | | | | | | |
| Edenor ® | 2.4% | 2.4% | 2.4% | 2.4% | 2.4% | 2.4% |
| K12-18 | | | | | | |
| Citric acid | 3% | 3% | 3% | 3% | 3% | 3% |
| 1,2- | 6% | 6% | 6% | 6% | 6% | 6% |
| propanediol | | | | | | |
| Ethanol | 2% | 2% | 2% | 2% | 2% | 2% |
| Inventive | — | 1% | — | — | 1% | 1% |
| block Polymer | | Ex. 2 | | | Ex. 2 | Ex. 2 |
| Tinosan ® HP | — | — | 0.3% | | 0.3% | |
| 100 | | | | | | |
| 2- | — | — | — | 1% | | 1% |
| Phenoxyethanol | | | | | | |
| NaOH | Up to pH = 8.5 | | | | | |
| Water | Up to 100% | | | | | |
| Appearance | Clear, | Clear, | Clear, | Clear, | Clear, | Clear, |
| | slightly | slightly | slightly | slightly | slightly | slightly |
| | yellow, | yellow, | yellow, | yellow, | yellow, | yellow, |
| | viscous | viscous | viscous | viscous | viscous | viscous |
| | liquid | liquid | liquid | liquid | liquid | liquid |
| Absorbance at | 0.0040 | 0.0103 | 0.0030 | 0.0030 | 0.0104 | 0.0108 |
| 580 nm | | | | | | |
| Absorbance at | 0.000093 | 0.000043 | 0.000043 | 0.000033 | 0.000048 | 0.000048 |
| 860 nm | | | | | | |

| | G | H | I | G | K | L |
|---|---|---|---|---|---|---|
| Ingredients | (inv.) | (inv.) | (inv.) | (inv.) | (inv.) | (inv.) |
| Non-ionic | 5.4% | 5.4% | 5.4% | 5.4% | 5.4% | 5.4% |
| surfactant | | | | | | |
| AEO-2 | | | | | | |
| Anionic | 7.7% | 7.7% | 7.7% | 7.7% | 7.7% | 7.7% |
| surfactant AES | | | | | | |
| Anionic | 5.5% | 5.5% | 5.5% | 5.5% | 5.5% | 5.5% |
| surfactant LAS | | | | | | |
| Edenor ® | 2.4% | 2.4% | 2.4% | 2.4% | 2.4% | 2.4% |
| K12-18 | | | | | | |
| Citric acid | 3% | 3% | 3% | 3% | 3% | 3% |
| 1,2- | 6% | 6% | 6% | 6% | 6% | 6% |
| propanediol | | | | | | |
| Ethanol | 2% | 2% | 2% | 2% | 2% | 2% |
| Inventive | 1% | 1% | 1% | 1% | 1% | 1% |
| block Polymer | Ex. 3 | Ex. 3 | Ex. 4 | Ex. 4 | Ex. 6 | Ex. 6 |
| Tinosan ® HP | 0.3% | | 0.3% | | 0.3% | |
| 100 | | | | | | |
| 2- | | 1% | | 1% | | 1% |
| Phenoxyethanol | | | | | | |
| NaOH | Up to pH = 8.5 | | | | | |
| Water | Up to 100% | | | | | |
| Appearance | Clear, | Clear, | Clear, | Clear, | Clear, | Clear, |
| | slightly | slightly | slightly | slightly | slightly | slightly |
| | yellow, | yellow, | yellow, | yellow, | yellow, | yellow, |
| | viscous | viscous | viscous | viscous | viscous | viscous |
| | liquid | liquid | liquid | liquid | liquid | liquid |
| Absorbance at | 0.0103 | 0.0106 | 0.0124 | 0.0128 | 0.0102 | 0.0113 |
| 580 nm | | | | | | |
| Absorbance at | 0.00005 | 0.000047 | 0.000052 | 0.00005 | 0.000049 | 0.000049 |
| 860 nm | | | | | | |

Inv. = inventive example;
Comp. = comparative example

It is clear from the above table, that the present inventive polymer and Tinosan HP 100 or phenoxyethanol can be combined in a liquid laundry formulation without any instability or turbidity; the absorbance at 580 and 860 nm is very low showing the formulation is not turbid.

The inventive examples show a good antimicrobial activity.

1. A block copolymer comprising a block A and a block B, wherein the block A comprises units deriving from at least one vinyl ester monomer, wherein the block B comprises units deriving from at least one monomer selected from the group consisting of ethylene oxide, 1,2-propylene oxide, 1,2-butylene oxide, 2,3-butylene oxide, 1,2-pentene oxide and 2,3-pentene oxide.

2. The block copolymer according to claim 1, wherein the block A comprises units deriving from at least one vinyl ester monomer selected from the group consisting of vinyl formate, vinyl acetate, vinyl haloacetate, vinyl propionate, vinyl butyrate, vinyl stearate, vinyl benzoate, vinyl pivalate, vinyl octanoate, vinyl neodecanoate and vinyl laurate.

3. The block copolymer according to claim 1, wherein the block B comprises repeating units selected from the group consisting of ethylene oxide, propylene oxide and butylene oxide.

4. The block copolymer according to claim 1, wherein the block copolymer has a Mₙ in g/mol within a range of from 5000 to 15000.

5. The block copolymer according to claim 1, wherein the block B has a Mₙ in g/mol within a range of from 2500 to 8000.

6. The block copolymer according to claim 1, wherein the block A has a Mₙ in g/mol within a range of from 200 to 10000 g/mol.

7. The block copolymer according to claim 1, wherein the number average molecular weight (Mₙ) ratio of the block B to the block A is within a range of from 0.4:1 to 15:1.

8. The block copolymer according to claim 1, wherein the degree of polymerization of the block B is in a range of from 70 to 170, and the degree of polymerization of the block A is in the range of 1 to 120.

9. The block copolymer according to claim 1, wherein the biodegradability of the block copolymer is at least 45%, within 28 days when tested under OECD301F.

10. The block copolymer according to claim 1, obtained by a living or controlled free-radical polymerization process.

11. A process for preparation of the block copolymer according to claim 1, comprising: a) reacting at least one monomer selected from the group consisting of ethylene oxide, 1,2-propylene oxide, 1,2-butyl oxide, 2,3-butylene oxide, 1,2-pentene oxide, optionally a radical initiator, and a chain transfer agent, to obtain the first block B, the transfer agent being attached to the block B; b) reacting the block B, at least one vinyl ester monomer, optionally at least one radical initiator to obtain the block copolymer; wherein the chain transfer agent is selected from the group consisting of dithioesters, thioethers-thiones, trithiocarbonates, dithiocarbamates, xanthates, their derivatives and mixtures thereof.

12. The process according to claim 11, wherein the chain transfer agent is xanthate or its derivatives.

13. A composition comprising the block copolymer according to claim 1, and at least one surfactant selected from the group consisting of anionic surfactant, nonionic surfactant, cationic surfactant, amphoteric surfactant, zwitterionic surfactant and a mixture thereof.

14. The composition according to claim 13, wherein the block copolymer is present in an amount of from 0.05% to about 20% by weight of the total composition.

15. The composition according to claim 13, comprising at least one surfactant in an amount of 1% to 70% by weight of the composition.

16. The composition according to claim 13, wherein the block copolymer is a (block A)-(block B) diblock copolymer or a (block A)-(block B)-(block A) triblock copolymer, wherein the block A is derived from vinyl ester monomer and the block B is derived from ethylene oxide monomer.

17. The composition according to claim 13, wherein the detersive surfactant is selected from the group consisting of anionic surfactant, non-ionic surfactant, and mixture thereof.

18. The composition according to claim 13, which comprises 2-phenoxyethanol in an amount of 2 ppm to 5% based on the total weight of the detergent composition.

19. The composition according to claim 13, which comprises 4,4′-dichloro-2-hydroxydiphenylether in an amount of 0.001 to 3% based on the total weight of the detergent composition.

20. The composition according to claim 13, wherein the composition comprises at least one enzyme.

21. A method of preserving an aqueous detergent composition comprising the block copolymer according to claim 1 against microbial contamination or growth, which comprises adding 2-phenoxyethanol in the detergent composition.

22. A method of laundering fabric or cleaning hard surfaces, which comprises an antimicrobial treatment of a fabric or a hard surface with a detergent composition comprising the block copolymer according to claim 1 and 4,4′-dichloro-2-hydroxydiphenylether.

23. A method comprising contacting a fabric with a composition at least comprising the block copolymer according to claim 1.

24. A method of using the block copolymer according to claim 1, the method comprising using the block copolymer in a fabric and home care product, a cleaning composition, an industrial and institutional cleaning product, cosmetic or personal care product, an oil field-formulation, a crude oil emulsion breaker, a pigment dispersion, inks, ink-jet inks, an electro-plating product, a cementitious composition, a lacquer, a paint, or agrochemical formulations.
